(19) United States
(12) Patent Application Publication
(10) Pub. No.: US 2006/0166179 A1
(43) Pub. Date: Jul. 27, 2006

(54) System and method for assessment of basic concepts

(76) Inventor: Elisabeth H. Wiig, Arlington, TX (US)

Correspondence Address: MCNAIR LAW FIRM, P.A., P.O. BOX 10827, GREENVILLE, SC, 29603-0827, US

(21) Appl. No.: 11/041,546

(22) Filed: Jan. 24, 2005

(51) Int. Cl. G09B 3/00

(52) U.S. Cl. 434/322; 434/353

(57) ABSTRACT

The present invention provides for a system for assessing an individual's understanding of basic concepts comprising a basic concepts assessment book having at least one illustration showing at least one basic concept, a correct receptive response associated with at least one illustration for comparison with a receptive response given by the individual being tested according to a receptive inquiry associated with at least one illustration and a correct expressive response for comparison with an expressive response given by the individual according to an expressive inquiry associated with at least one illustration. The invention tests basic concepts using related pairs. Further, the system associates a receptive score representing a comparison between the correct receptive response and the receptive response, an expressive score representing the comparison between the correct expressive response and the expressive response, whereby an individual's understanding of basic concepts is assessed expressively and receptively with inquiries associated with at least one illustration.

### FIELD OF THE INVENTION

This invention relates to a system and method for the assessment of basic concepts. Specifically, the invention relates to the use of a book to receptively and expressively assess basic concepts.

### BACKGROUND OF THE INVENTION

In the education of children, it is common to administer and assess the understandings of a child. One of the fundamental skills that a child should develop is a solid understanding of “basic concepts.” Basic concepts are the building blocks that children use to follow directions, engage in classroom routines, and provide descriptions of the world around them. Basic concepts are instrumental in performing tasks such as reading, writing, speaking, and arithmetic. Basic concepts are integrated in nearly every aspect of classroom subjects and the more knowledge a child has of basic concepts, the more advanced the academic achievement of the child will be. Generally, basic concepts can be divided into seven categories. These categories are: color/shape; weight/forms; distance/speed/time; quantity/completeness; location/direction/condition/quality; sensation/emotion/valuation. For example, category of color/shape may include testing of the child's ability to distinguish between square and round, blue and red, green and yellow, and orange and brown. Further, there are two types of methods for assessing basic concepts categorized as receptive and expressive. Receptive testing of basic concepts involves pointing and other non-verbal responses to questions or prompts asked during testing. Expressive testing of basic concepts involves verbal responses to questions or prompts asked during testing.

Prior attempts at systems for assessing basic concepts have utilized easels to present questions about basic concepts. Traditional tests used color drawings presented on the easel for having an individual administer the tests. The concepts are presented orally to the students and the child traditionally chooses from multiple choice items by pointing or making a verbal response to the question. The scoring of these traditional tests uses a one point for correct and a zero point for incorrect scoring system. The concepts are presented randomly, with no relationship between concepts tested on a given illustration.

None of the previous tests present the testing material in a storybook format. This format is more preferable to that of an easel because it provides a natural context. Further, none of the existing tests present the tested concepts in pairs such as hot and cold, tested together. This is important because children do not have a concept of temperature unless they are able to identify both ends of the continuum, hot and cold. Further, none of the existing tests assess the individual's knowledge of basic concepts, both expressively and receptively.

Therefore, a system and method for assessing the basic concepts of a child is needed that evaluates both the receptive and expressive concepts, presents the concepts in opposite or related parts, rather than single, unrelated concepts, and is presented in a format that does not involve an easel.

### SUMMARY OF THE INVENTION

The present invention provides a system for assessing an individual's understanding of basic concepts comprising a basic concepts assessment book having at least one illustration showing at least one basic concept, a correct receptive response associated with at least one illustration for comparison with a receptive response given by the individual being tested according to a receptive inquiry associated with at least one illustration and a correct expressive response for comparison with an expressive response given by the individual according to an expressive inquiry associated with at least one illustration. Further, the system associates a receptive score representing a comparison between the correct receptive response and the receptive response, an expressive score representing the comparison between the correct expressive response and the expressive response, whereby an individual's understanding of basic concepts is assessed expressively and receptively with inquiries associated with at least one illustration.

Additionally, a set of correct expressive responses for comparison with the expressive response given by the individual according to the expressive inquiry associated with at least one illustration is present in the invention. The expressive score represents the comparison between the expressive response and each member of a set of correct expressive responses. The set of correct expressive responses includes at least one acceptable response for comparison with an expressive response given by the individual according to an expressive inquiry associated with at least one illustration and thus, a lower expressive score represents the comparison between an acceptable response and an expressive response.

Further, the present invention comprises a set of conversion data representing at least one raw score representing the sum of the expressive and receptive score, and a standard score associated with the raw score for converting the raw score to an associated standard score. A set of ranking data for determining a percentile rank corresponds to the standard receptive score. Additionally, a set of age data for determining the age equivalency of the individual according to the receptive score so that an age is associated with the individual's understanding of basic skills is present in the invention.

A basic concepts assessment book containing a plurality of pages, each containing an illustration and text, representing a story that can be read to the individual while assessing their understanding of basic concepts is presented. The illustration contains a plurality of concepts that are at least one related pair. The system comprises a record form for recording the receptive and expressive scores of an individual being assessed. The record form includes the correct expressive response and the correct receptive response. In a further embodiment, two assessment books are used.

The present invention includes a method for the assessment of an individuals understanding of basic concepts using an assessment book having illustrated pages. The individual is asked a question based on an illustrated page of the assessment book to elicit a receptive response, thereby comparing the receptive response of the individual to a predetermined correct receptive response. The receptive response is scored based on the comparison of the individual's receptive response and the predetermined correct receptive response. Next, the individual is asked a question based on the same illustrated page of the assessment book to elicit an expressive response. The expressive response of the individual is compared to a predetermined correct expressive response, and an expressive response is recorded based on the comparison of the individual's expressive response with the predetermined correct expressive response.

A comparison is made of an individual's expressive response to at least one acceptable response, and recording an expressive score lower than the expressive score associated with the comparison of the response and the correct expressive response based on the comparison of the individual's expressive response with at least one acceptable response. Receptive and expressive questions are asked based on the same illustration. A standard score is determined, based on a comparison of the individual's raw score and associated standard scores on a chart containing scores and standard scores associated with each other. Based on certain steps, the individual is asked questions to elicit a receptive response and an expressive response, which are both associated with the same illustrated page of the assessment book.

### DESCRIPTION OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 is an illustration of the invention being used by a teacher to assess the concepts of a student;

FIG. 2 is a perspective view of the assessment book open to an illustrated page;

FIG. 3 is a front view of a portion of the assessment sheet;

FIG. 4 is an illustration of the assessment sheet; and

### DESCRIPTION OF A PREFERRED EMBODIMENT

Referring now in more detail to the drawings, the invention will be described in more detail.

This invention is a system and method for assessment of basic concepts. The system uses a storybook format to present multiple illustrations used to assess a variety of basic concepts. Each page in the assessment book contains an illustration depicting a scene in the story. More importantly, each illustration depicts basic concepts to be assessed. For example, the illustrations may include a bear inside a cave and a bear outside of a cave. This allows the administrator to test the concept inside and outside. Further, the test is designed to test receptively and expressively. The receptive response occurs first with the student pointing to the bear that is inside in response to a cue by the administrator of the test. The expressive response comes when the administrator of the test points to the bear outside and asks the student where the bear is. If the student replies “outside” his/her response is correct and thus will receive two points. The invention is described in more detail below.

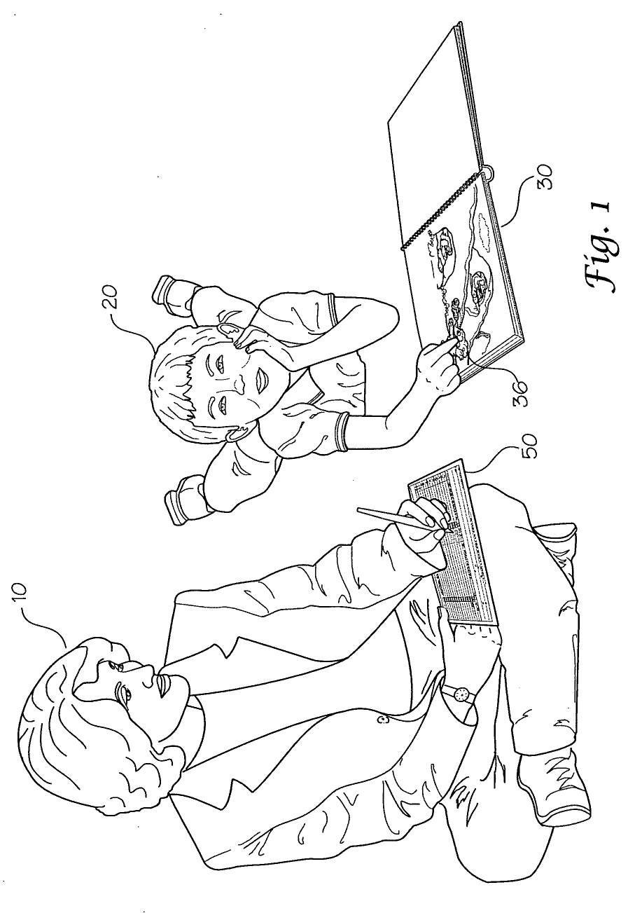

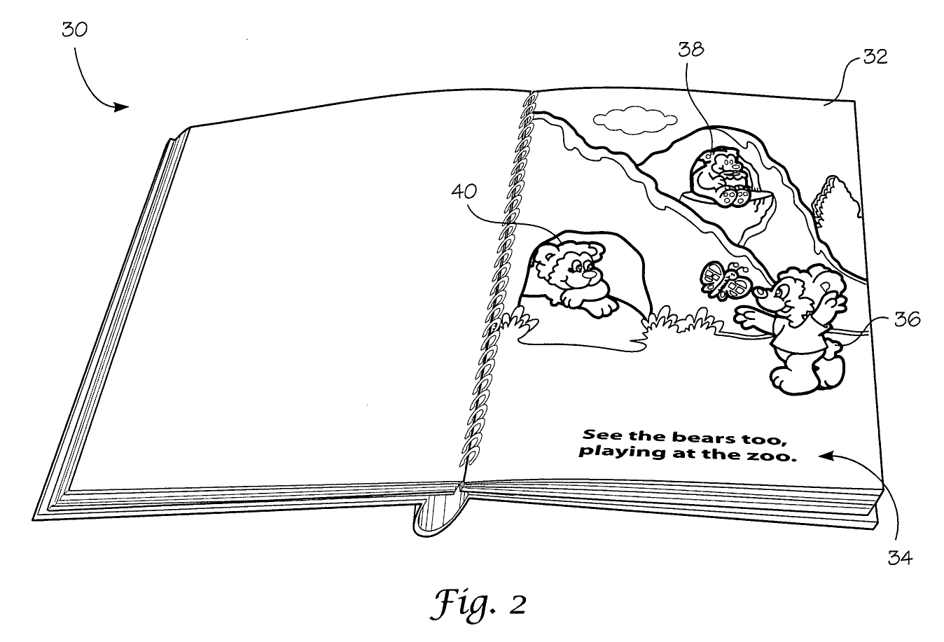

Referring now to FIG. 1, the invention is described in more detail. Examiner 10 is administering the assessment of basic concepts to student 20. Student 20 has assessment book 30 in front of him. Assessment book 30 is open to illustrated page 36 depicting an illustration shown in more detail in FIG. 2. The administrator or examiner of the test 10 is using record form 50 to score student 20 responds to the assessment.

Basic concepts such as colors, numbers, location words, and descriptive words are the building blocks that children need to communicate, follow directions, engage in classroom routines, and provide descriptions of everyday items. For example, children should be able to understand and differentiate verbally the size of an object as being big or small. Children should also be able to understand and differentiate the location of an object such as inside or outside. Understanding these concepts is fundamental so that children can perform everyday tasks such as listening, speaking, reading, writing, and arithmetic.

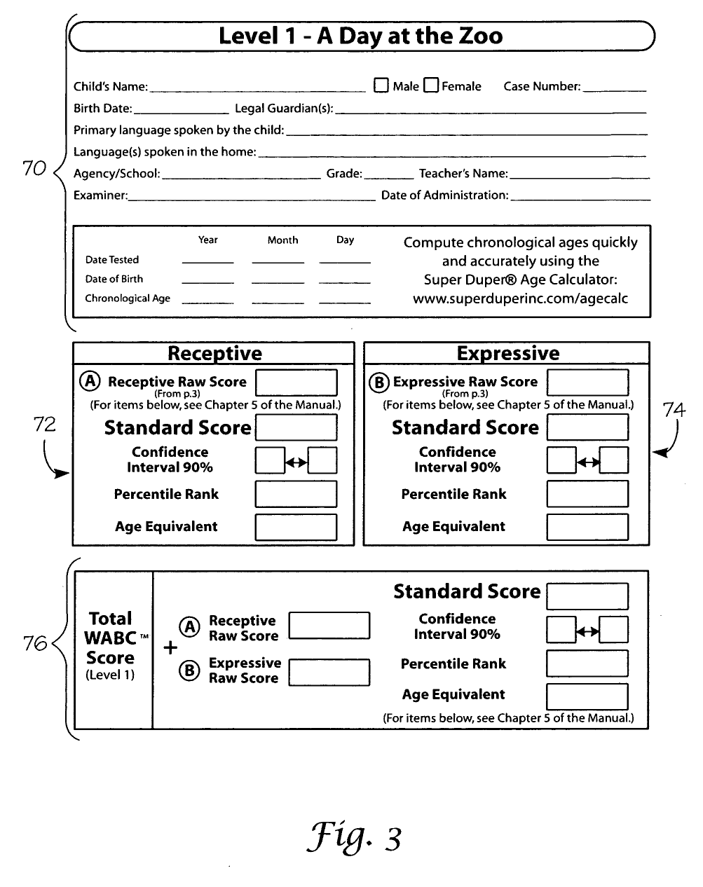

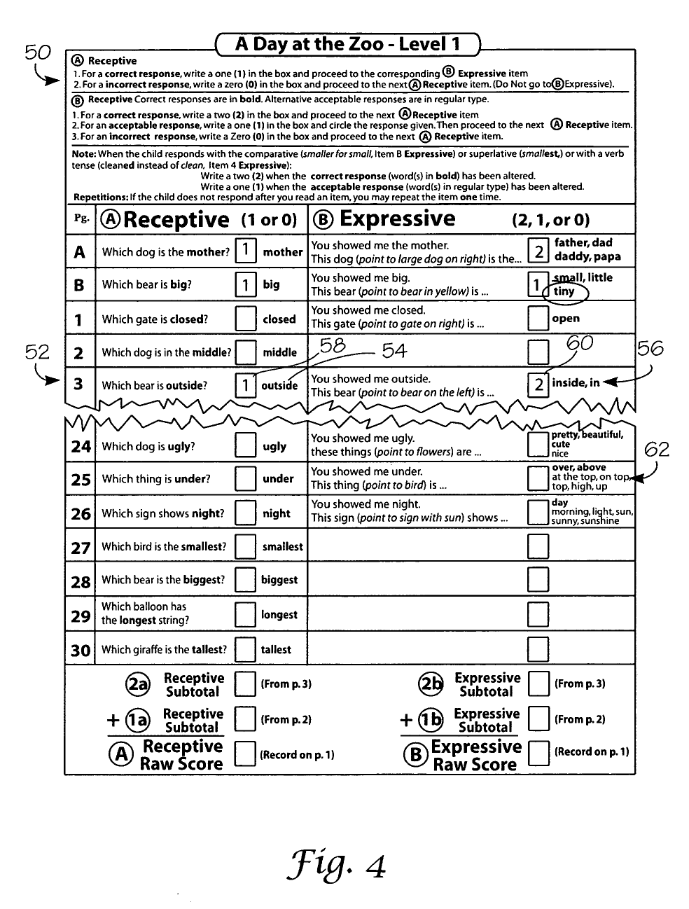

Each illustration in the testing book shows three pictured choices. One of the pictures (such as the one shown as 36) in the scene shows the receptive (pointing) target (big). Another picture in the scene exemplifies the expressive (naming) target (little). The third picture depicts a concept “in between” the two target concepts, and acts as a foil (a middle-sized bear). Record form 50 is used to record responses of the individual being tested and is shown in more detail in FIGS. 3 and 4. The stimulus items used to elicit the receptive (pointing) and expressive (naming) responses are printed on the corresponding record forms. The opposite or related word pairs depicted in each scene elicit a receptive and an expressive response based on certain features in each illustration.

The examiner should explain the process of pointing and naming used by the exam to the student. When the child understands the tasks of pointing and naming, the examiner should proceed to administering the assessment. To begin the assessment, examiner 10 may then turn to the first test page of the story and introduce it. Examiner 10 may read the optional story text, or may choose to say something else to put the child at ease. (For example, “Here is another picture. Let's look at it. I×ll ask you to point to something and then to tell me something—just like we did before.”) Examiner 10 should wait for the child 20 to indicate he understands before beginning the test. All test stimulus items should be administered verbatim and in standard format. Reading the text at the bottom of each page is optional. When the examiner reads the text before the stimulus items, it gives the child time to look at the illustration before she or he is asked to respond.

When the examiner turns to a new story page, the child may want to point or talk spontaneously about it. After a few seconds, the examiner may say to the child, “Let's listen to the story now!” When the child is attentive, the examiner may read the optional story text shown generally as 34 in large, bold print in a story-telling voice. First, examiner 10 reads the receptive inquiry for eliciting a pointing (receptive) response (“Which gate is closed?”). Examiner 10 should wait 5 to 10 seconds for the child to respond and then repeat the question, if necessary. If child 20 does not respond after another 5 to 10 seconds, examiner 10 should not continue with the corresponding expressive stimulus item. If child 20 points (receptive) to the wrong response (a foil or prop), examiner 10 should not correct the child. If child 20 responds correctly to the receptive inquiry, examiner 10 should read the expressive inquiry and wait 5 to 10 seconds for child 20 to verbally respond. If child 20 does not verbally respond, examiner 10 may repeat the expressive inquiry and wait another 5 seconds. If child 20 produces an incorrect response, examiner 10 should not correct the child. Examiner 10 should go to the next receptive item and say, for example, “Here is another picture,” or “Let's move on.” Examiner 10 should repeat this procedure for the next stimulus item.

For example, FIG. 2 shows an illustration used in the assessment, shown generally as 36. It depicts three bears, one completely inside a cave, one partially inside a cave, and one playing outside. Examiner 10 asks the child a receptive inquiry that is used to elicit the receptive, pointing response for “outside.” As shown on the assessment sheet in FIG. 4, the examiner asks the child, “Which bear is outside?” As shown in FIG. 1, the child points [correctly] to the bear that is outside. The child is then shown the bear in the cave to elicit the expressive, naming response “inside.” Again, as shown in FIG. 4, the examiner reads the expressive inquiry, “You showed me outside. This bear [Examiner points to the bear in the cave] is . . . ,” and the child says, [correctly] “inside or in”). For many test items, but not all, the least preferred (often later-developing) concept in a word pair is used to elicit a pointing response, while the preferred (often earlier-developing) concept is used to elicit a naming response. Note that the illustration described above does not use a pair in this manner. For example, the usually least preferred concept word “outside” may be used to elicit a receptive response, while the usually preferred concept word “inside” is used to elicit an expressive response. As an example, some children may prefer “big” toys (cars, dolls) early on, but change their preference to “small” toys (miniature dolls, cars) as they get older. The receptive and expressive responses are elicited in relation to certain characteristics of people, animals, or objects featured in each scene.

During testing, Examiner 10 records and scores the Receptive and Expressive responses to each test stimulus in the spaces provided on the record form shown in FIGS. 3 and 4. FIG. 4 shows the scoring short portion of the record form. On the Receptive items, the system uses a 1 (correct response) or 0 (incorrect response) point system. On the Expressive items, the system may use a 2 (correct response), 1 (acceptable response), or 0 (incorrect response) point system. If the child gives a correct Receptive response, or self-corrects a Receptive error within three seconds, then the examiner should count the response as correct and score as a one (1). The examiner should score all responses that are not correct as a zero (0). For example, for the illustration shown in FIG. 2, the receptive and expressive questions are shown on the Record Form depicted in FIG. 4, generally as 52. The receptive question asked is “which bear is outside?” The correct receptive response outside is shown as 54. As is shown on FIG. 1, the student 20 is correctly pointing at the bear that is outside. Thus, examiner 10 has marked 1 in the answer box 58 indicating a correct receptive response. If the child gives a correct Expressive response (the words in bold type), or self-corrects an Expressive error within three seconds, then the examiner should count the response as correct and score as a two (2). If the child gives an Expressive response that is an acceptable response, either immediate or self-corrected, then the examiner should score it as a one (1) on the record form. Also, the examiner may circle the acceptable response given by the child. The examiner scores all responses that are not correct as a zero (0) for the Expressive test item. For example, again using the illustration from FIG. 2, the expressive inquiry that is asked is “this bear (pointing to the bear on the left) is ______.” The set of correct expressive responses shown generally as 56 are “inside” and “in.” As the student has given one of these two responses about this bear, the examiner has indicated a score of 2 shown generally as 60. There are certain questions that have acceptable expressive responses in the set of correct expressive responses as well as correct responses. For example, the item shown generally as 62 has the set of correct responses of “over” and “above”. Further, “at the top”, “on top”. “top”; “high”, and “up” are shown as acceptable response. Any of those responses would result in a score of 1. Any response that was neither one of the two correct responses nor one of the five acceptable responses would receive a score of zero. The correct Expressive response is weighted double (2) to reflect that it is more difficult than the correct Receptive response, which is weighted (1). The Total Raw Score for an item (Receptive Raw Score+Expressive Raw Score) reflects the relative levels of difficulty for that item. It factors in the difference in the level of difficulty a child has in responding accurately to the Receptive versus the Expressive stimulus items.

As can best be seen in FIG. 3, the front page of the assessment sheet has several areas where information may be entered. Included in these areas are information area 70. This information area allows the administrator of the test to enter in information about the child being tested and the date of the test. A receptive area 72 is included for inputting the receptive raw score of the student. There are also spaces for inputting a standard score and a percentile rank and age equivalent for the receptive score. These numbers are determined by looking up the raw score of the individual being tested on a chart in the manual (not shown). Each raw score has a corresponding standard score and percentile rank and age equivalent. The instructor would input this information in this area. As above, the instructor would input the expressive raw score and the corresponding standard score, percentile rank, and age equivalent for the expressive score in area 74. In area 76, the instructor enters the receptive raw score and expressive raw score to determine a total score and a corresponding standard score. As with the receptive and expressive entries, the instructor can look up the standard score on the chart in the manual associated with administering the test and determine the percentile rank and age equivalent associated with that standard score. Thus, a standardized score, percentile rank and age equivalent are available for the student's total score, receptive score and expressive score. These easy to read numbers are often desired by parents of the student being assessed.

While a preferred embodiment of the invention has been described using specific terms, such description is for illustrative purposes only, and it is to be understood that changes and variations may be made without departing from the spirit or scope of the following claims.

What is claimed is:

1. A system for assessing an individual's understanding of basic concepts comprising:
a basic concepts assessment book having at least one illustration showing at least one basic concept;
a correct receptive response associated with said at least one illustration for comparison with a receptive response given by the individual being tested according to a receptive inquiry associated with said at least one illustration;
a correct expressive response for comparison with an expressive response given by the individual according to an expressive inquiry associated with at least one illustration; and
a receptive score representing said comparison between said correct receptive response and said receptive response; and
an expressive score representing said comparison between said correct expressive response and said expressive response; whereby
an individual's understanding of basic concepts is assessed expressively and receptively with inquiries associated with said at least one illustration.

2. The system of claim 1 including:
a set of correct expressive responses for comparison with the expressive response given by the individual according to the expressive inquiry associated with said at least one illustration;
said expressive score representing said comparison between said expressive response and each member of said set of correct expressive responses.

3. The system of claim 2 wherein said set of correct expressive responses includes at least one acceptable response for comparison with an expressive response given by the individual according to an expressive inquiry associated with said at least one illustration; and,
wherein a lower expressive score represents said comparison between said acceptable response and said expressive response.

4. The system of claim 1 having:
a set of conversion data representing at least one raw score representing the sum of the expressive and receptive score; and,
a standard score associated with the raw score for converting the raw score to an associated standard score.

5. The system of claim 4 including a set of ranking data for determining a percentile rank corresponding to the standard receptive score.

6. The system of claim 4 including a set of age data for determining the age equivalent of the individual according to said receptive score so that an age is associated with the individual's understanding of basic skill.

7. The system of claim 1 wherein said basic concepts assessment book contains a plurality of pages each containing an illustration and text representing a story that can be read to the individual while assessing their understanding of basic concepts.

8. The system of claim 1 wherein said illustration contains a plurality of concepts that are at least one related pair.

9. The system of claim 1 further comprising a record form for recording the receptive and expressive scores of an individual being assessed.

10. The system of claim 9 wherein said record form includes said correct expressive response and said correct receptive response.

11. A method for the assessment of an individual's understanding of basic concepts using an assessment book having illustrated pages comprising the steps of:
asking the individual a question based on an illustrated page of the assessment book used to elicit a receptive response;
comparing the receptive response of the individual to a predetermined correct receptive response;
recording a receptive score based on the comparison of the individual's receptive response and the predetermined correct receptive response;
asking the individual a question based on an illustrated page of the assessment book used to elicit an expressive response;
comparing the expressive response of the individual to a predetermined correct expressive response; and
recording an expressive score based on the comparison of the individual's expressive response with the predetermined correct expressive response.

12. The method of claim 11 further comprising the steps of:
comparing an individual's expressive response to at least one acceptable response, and recording an expressive score lower than the expressive score associated with the comparison of the response and the correct expressive response based on the comparison of the individual's expressive response with the at least one acceptable response.

13. The method of claim 11 further comprising the step of:
asking the receptive and expressive questions based on the same illustration.

14. The method of claim 11 further comprising the step of:
determining a standard score based on a comparison of the individual's raw score and associated standard scores on a chart containing scores and standard scores associated with each other.

15. The method of claim 11 wherein said steps of asking the individual a question to elicit a receptive response and asking the individual a question to elicit an expressive response are both associated with the same illustrated page of the assessment book.
